(19) United States
(12) Patent Application Publication
(10) Pub. No.: US 2013/0117287 A1
(43) Pub. Date: May 9, 2013

(54) METHODS AND SYSTEMS FOR CONSTRUCTING PERSONAL PROFILES FROM CONTACT DATA

(71) Applicant: salesforce.com, inc., San Francisco, CA (US)

(72) Inventors: Arun Jagota, Sunnyvale, CA (US); Pawan Nachnani, San Mateo, CA (US)

(73) Assignee: salesforce.com, inc., San Francisco, CA (US)

(21) Appl. No.: 13/667,347

(22) Filed: Nov. 2, 2012

Related U.S. Application Data
(60) Provisional application No. 61/555,558, filed on Nov. 4, 2011.

(51) Int. Cl. G06F 17/30

(52) U.S. Cl. 707/755; 707/E17.009

(57) ABSTRACT

A system and method for building a profile record for a person. Email addresses and corresponding person names are extracted from an email message and stored as records each record having an email address and corresponding person name as a key/value pair. A pair of such records is compared. If the person names are known for both records, then a match between the person names is evaluated. If the person name is known for only one of the records, then a match between the known person name for the one record and an email prefix for the other record is evaluated. If the person name is not known for either record, then a match between the email prefixes for both records is evaluated.

### PRIORITY CLAIM

The present application claims the benefit of U.S. Provisional Patent App. No. 61/555,558, filed on Nov. 4, 2011, entitled “A System and Method for Constructing Person Profiles from Contact Data” (Attorney Docket No. 794PROV), which is expressly incorporated herein by reference in its entirety.

### COPYRIGHT NOTICE

Portions of this disclosure contain material which is subject to copyright protection. The copyright owner has no objection to the facsimile reproduction by anyone of the patent document or the patent disclosure, as it appears in the records of the United States Patent and Trademark Office, but otherwise reserves all rights.

### TECHNICAL FIELD

This disclosure relates generally to systems, computer program products, and computer methods for managing database records, and more particularly, for creating a individual profile from a collection of business card records.

### BACKGROUND

An ongoing business enterprise uses and maintains data related to the company's business, such as sales numbers, customer contacts, business opportunities, and other information pertinent to sales, revenue, inventory, networking, etc. The data is stored on a database that is accessible to company employees, and frequently, a third party maintains the database containing the data. For example, the database can be a multi-tenant database, which maintains data and provides access to the data for a number of different companies.

Business cards are the lifeblood of many sales organizations, and such contact information may be maintained on the database. However, keeping this information current can be tedious, particularly when individuals move from one job to another. As a result of such movement, the database may keep multiple business cards of the same individual, which may reflect a new position within the same company, or a new position with a different company.

In either event, it would be desirable to provide systems and methods that permit the database to be updated to that multiple business cards are actually tied to the same individual, and further, to provide a person profile for the individual that includes a work history across the multiple business cards stored in the database.

### BRIEF DESCRIPTION OF THE DRAWINGS

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements. Although the following figures depict various examples of the invention, the invention is not limited to the examples depicted in the figures.

FIG. 1 is a simplified block diagram illustrating one embodiment of a multi-tenant database system (“MTS”);

FIG. 2A is a block diagram illustrating an example of an environment wherein an on-demand database service might be used;

FIG. 2B is a block diagram illustrating an embodiment of elements of FIG. 2A and various possible interconnections between those elements;

FIG. 3A is block diagram illustrating a schema for a database record for business contacts, and individual business contact records built according to the schema.

FIG. 3B is block diagram illustrating a schema for a database record for a personal profile.

FIG. 4 is a flow chart illustrating a process for matching contacts.

FIG. 5 is a flow chart illustrating a process for clustering matched contacts.

FIG. 6 is a block diagram illustrating an email message.

FIG. 7 is a flow chart illustrating a process for analyzing email messages.

FIG. 8 is a flow chart illustrating a process for evaluating prefixes of email addresses.

### DETAILED DESCRIPTION

This disclosure describes systems and methods for building a profile record of a person. An email address and a corresponding person name may be extracted from an email message and stored as a key/value pair. A pair of such records is compared. If the person names are known for both records, then a match between the person names is evaluated. If the person name is known for only one of the records, then a match between the known person name for the one record and an email prefix for the other record is evaluated. If the person name is not known for either record, then a match between the email prefixes for both records is evaluated.

1. Hardware/Software Environment

In general, the methods described herein may be implemented as software routines forming part of a database system. As used herein, the term multi-tenant database system refers to those systems in which various elements of hardware and software of the database system may be shared by one or more customers. As used herein, the term query refers to a set of steps used to access information stored in a database system.

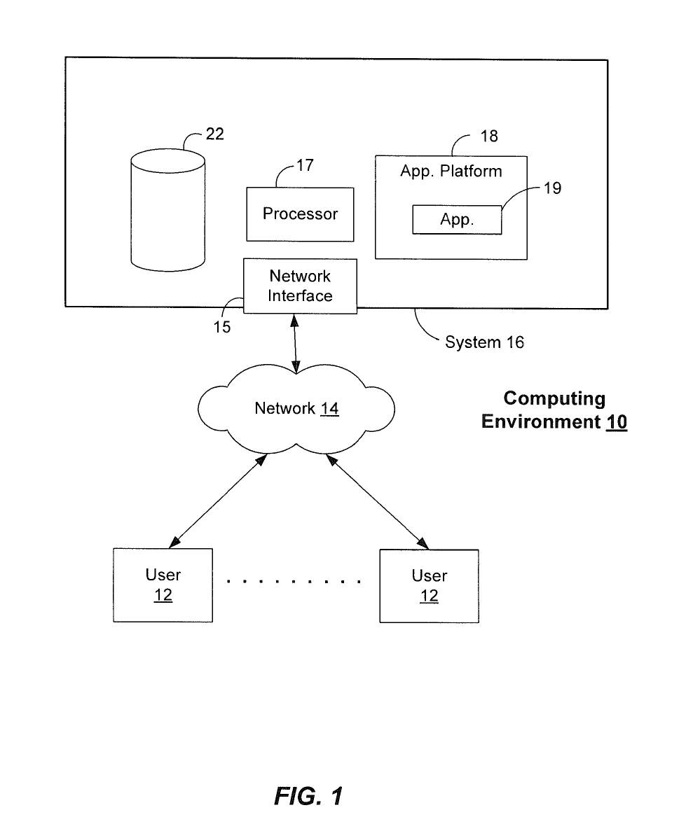

FIG. 1 is a simplified block diagram illustrating one embodiment of an on-demand, multi-tenant database system (“MTS”) 16 operating within a computing environment 10. User devices or systems 12 access and communicate with MTS 16 through network 14 in a known manner. User devices 12 may be any computing device, such as a desktop computer, laptop computer, digital cellular telephone, or any other processor-based user device, and network 14 may be any type of computing network, such as a local area network (LAN), wide area network (WAN), the Internet, etc.

The operation of MTS 16 is controlled by a processor 17, and network interface 15 manages inbound and outbound communications between the network 14 and the MTS. One or more applications 19 are managed and operated by the MTS 16 through application platform 18. For example, a database management application runs on application platform 18 and provides program instructions executed by the processor 17 for indexing, accessing and storing information for the database. In addition, a number of methods are described herein which may be incorporated, preferably as software routines, into the database management application.

MTS 16 provides the users of user systems 12 with managed access to many features and applications, including tenant data storage 22, which is configured through the MTS to maintain tenant data for multiple users/tenants. The tenant storage 22 and other processor resources may be available locally within system 16 as shown, or hosted remotely with high speed access.

2. Objects, Records and Fields

Any database including MTS 16 is comprised of a number of entities, or objects, that represent tables containing the information of one or more organizations. Each entity may have related child objects that define the entity. For example, a common business object represents Accounts, such as customers, partners and competitors, and may have related child objects including one or more data feeds. Both the entity object (also called the base object) and its child objects have records associated with them which may include data defining the object as well as one or more data fields having values or links which are referenced in operations involving the object.

The objects are typically accessible through an application programming interface (API), which is provided through a software application, for example, a customer relationship management (CRM) software product, such as Salesforce CRM. The term “record” is used to describe a specific instance of an object, like a specific customer account that is represented by an account object. A record may be thought of as simply a row in a database table. In a typical database application, standard objects may be provided, while custom objects may be created by the user.

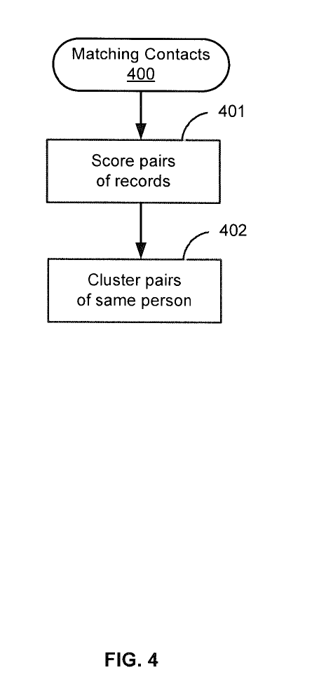

Each database can generally be viewed as a collection of objects, such as a set of logical tables, containing data fitted into predefined categories. A “table” is one representation of a data object, and may be used herein to simplify the conceptual description of objects and custom objects. It should be understood that the terms “table” and “object” may be used interchangeably herein. Each table generally contains one or more data categories logically arranged as columns or fields in a viewable schema, such as illustrated in FIGS. 4A-4D and described below. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with the terms “object” and “table.”

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled Custom Entities and Fields in a Multi-Tenant Database System, is hereby incorporated herein by reference, and teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

It should also be noted that users may only access objects for which they have authorization, as determined by the organization configuration, user permissions and access settings, data sharing model, and/or other factors related specifically to the system and its objects. For example, users of the database can subscribe to one or more objects on the database in order to access, create and update records related to the objects, including data feeds or dashboard applications.

3. Business Contact Records

Users of MTS 16 have access to large numbers of business contacts, typically by subscription. For example, the data.com Contacts by Jigsaw® database now has records for over 30 million business contacts.

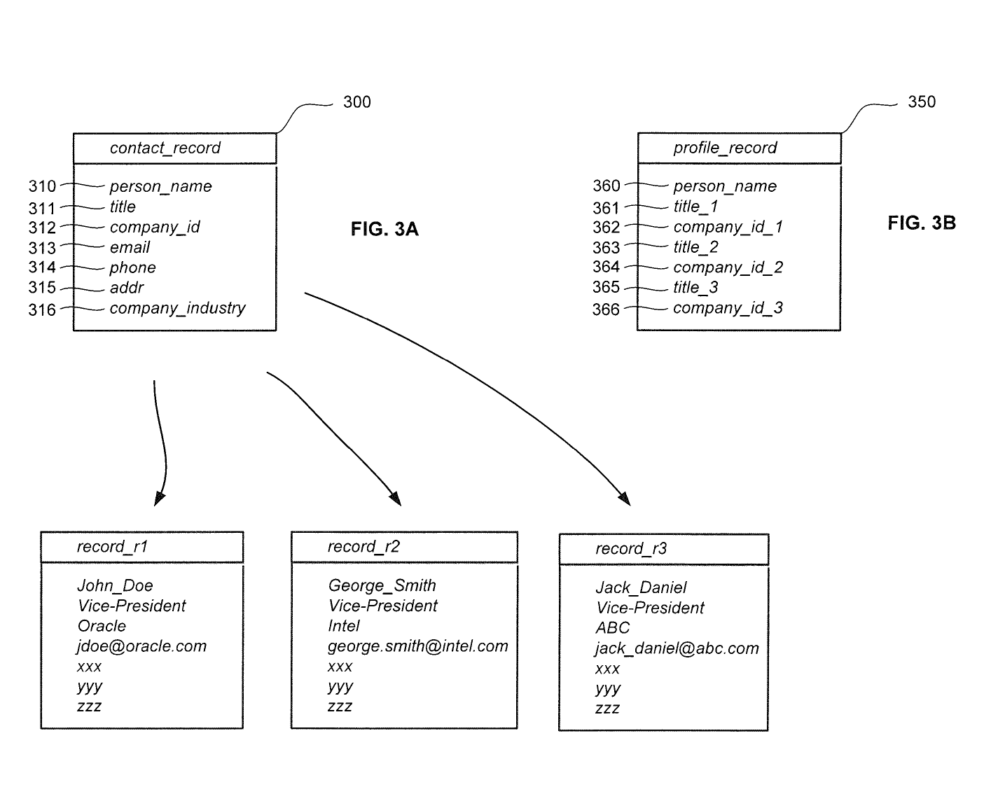

Referring now to FIG. 3A, a schema 300 for a database record called contact record is illustrated. Individual records r1, r2, and r3, for example, are created according to the schema and each record represents a business card or contact for a single individual. A number of fields define the schema 300. In this example, fields 310-316 are illustrated, but of course other fields may be defined. Field 310 (person_name) is for the person's name and typically has at least two sub-field objects, namely first_name and last_name, although other field variations are common, as further described below, including flast (i.e., first initial plus last_name, which is commonly used in email addressing schemas). Field 311 (title) represents the title or position of the individual. Field 312 (company_id) represents the company the individual works for. Field 313 (email) represents the email address for the individual. Field 314 (phone) represents the phone number for the individual. Field 315 (address) contains the company address for the individual. Field 316 (company_industries) contains a description of the industry characterization of the individual. The fields described are merely illustrative and could include many other fields or alternative fields. A database such as MTS 16 may be configured to store and access business cards such as records r1, r2, etc.

Given the frequency with which people move to new jobs, a personal profile may be created for an individual based on the business card data. For example, there may be multiple business cards for the same individual within the database, from different companies, and from this information we can build an individual work history as part of the personal profile. For example, a schema 350 for another database record is illustrated in FIG. 3B, and fields 360-366 are illustrated as defining this schema, but of course other fields may be defined. Field 360 (person_name) is again for the person's name. Field 361 (title_1) and field 362 (company_id_1) are the most recent title and company for the person. Field 363 (title_2) and field 364 (company_id_2) contain a prior title and company for the person, and likewise, field 365 (title_3) and field 366 (company_id_3) contain another prior title and company for the person. Additional fields may be defined in the schema 350 as desired.

4. Contact Matching

One embodiment of a process 400 for matching contacts across different companies is shown in FIG. 4. In step 401, contact records are “scored” one pair at a time with the likelihood that the pair of records represents the same person. Step 401 is a process unto itself, and is described in more detail below. In step 402, records that are likely to be associated with the same person are formed into a “cluster” using a suitable clustering technique. Clustering techniques are generally known, and U.S. Patent App. No. 2012/0023107 entitled System and Method of Matching and Merging Records, expressly incorporated herein by reference in its entirety, discloses one such method.

Step/Process 401 is an elaborate scoring function cast in a Bayesian framework. Let record r1 denote an individual in a first company, company A, and let record r2 denote an individual in a second company, company B. The following formulas give the probability that records r1 and r2 represent the same person (“S”) or a different person (“D”):

P(S|r₁,r₂,parameters)∝P(r₁,r₂|S,parameters)*P(S|parameters)

P(D|r₁,r₂,parameters)∝P(r₁,r₂|D,parameters)*P(D|parameters)

Since these equations are not equalities, but proportional equations, the probability values do not have to be calculated. Instead, the right side of these two equations can be compared. The objective is to find out which of S and D has the higher posterior value in these formulations. Denominators can be ignored, and the right-hand side of the equations can be log-transformed for convenience. Reinterpreting the results as score components yields the following equations:

score(S|r₁,r₂,parameters)=log P(r1,r2|S,parameters)+log P(S|parameters)

score(D|r1,r2,parameters)=log P(r1,r2|D,parameters)+log P(D|parameters)

The third term in each of the above equations {P(S|parameters) and P(D|parameters)} represents prior probabilities that contact records represent the same person (or different people) and can be estimated from a large training set if available, from our beliefs if not, or a combination of the two. An ideal training set would be a large random sample from the population of labeled pairs {r₁, r₂}, where r₁ and r₂ denote records in different companies having the same person name. The label on such a pair is S, denoting that the person is the same one, or D, denoting that the person is a different one.

The second term in each of the above equations (log P(r₁,r₂|X, assumptions), Xε{S, D}) represents the log-likelihoods that contact records represent the same person (or different people). This term is the most significant one for the purpose of calculating score functions.

We can design a set of mostly-independent features f that, taken collectively, accurately predict S versus D from the set of records {r₁, r₂}. The set of features allows us to factor the score functions as indicated below:

log P(r₁,r₂|X,parameters)=Σ_{f} log P(f(r₁,r₂),|X,parameters)

where f denotes a feature whose value is f(r₁, r₂).

Finally, the two score functions are combined into one in Equation (1):

$$\begin{matrix}score ( {r}_{1} , {r}_{2} , assumptions ) = score ( S \vert {r}_{1} , {r}_{2} , assumptions ) - \\ score ( D \vert {r}_{1} {r}_{2} , assumptions ) \\ = {\sum }_{f} log \frac{P ( f ( {r}_{1} , {r}_{2} ) , \vert S , parameters )}{P ( f ( {r}_{1} , {r}_{2} ) , \vert D , parameters )} - \\ \frac{log P ( S \vert parameters )}{log P ( D \vert parameters )}\end{matrix} \qquad ( 1 )$$

The first term sums over the log-likelihood ratios of features f for the two classes, and the second term is the log prior ratio of the two classes.

5. Person Names as a Feature

This is the tuple (f₁, f₂, l₁, l₂) of person names, split into first and last name, in the two records r₁ and r₂. Thus, the probabilities can be written as

P(f₁,f₂,l₁,l₂|X),Xε{S,D},

i.e. the likelihoods of getting the person names in the two classes S and D respectively, where S is the population of pairs of records in different companies of the same person, and D is the population of pairs of records in different companies of different persons having the same name (up to superficial differences).

If there are good training sets available for S and D (like the same ones described above for estimating priors), then these probabilities can be estimated from them. Such training sets can be laborious to construct, and so lacking them, an unsupervised heuristic scheme may be used instead. Rather than estimating the two probabilities (which is not possible without training sets for the two classes), an analogous unsupervised feature is used instead, as described below.

Let P(fᵢ, lᵢ) denote the probability of the person name (fᵢ, lᵢ). This probability may be estimated from a large database of business cards as

$$\frac{n ( {f}_{i} ) * n ( {l}_{i} )}{n}$$

where n(fᵢ) is the number of occurrences of fᵢ as a first name in the database, n(lᵢ) the number of occurrences of lᵢ as a last name in the database, and n the total number of business cards in the database. One would, for example, expect P(john, smith) to have a much higher likelihood than P(paulina, kobiski). Define P(f, l) as the geometric mean of P(f₁, l₁) and P(f₂, l₂). The lower P(f, l) is, the more confidence we have that records r1 and r2 are of the same person. So, in the equation score (r₁, r₂, parameters), a simplified approximation term −w₁*log P(f, l) is incorporated instead of the more accurate log-likelihood ratio of this feature. In this example, w₁ is a positive constant tuned on an evaluation set of positive results (two records in different companies of the same person) and negative results (two records in different companies with the same person name but of different persons). Note that tuning a single constant satisfactorily requires a much smaller evaluation set than that required for estimating the log-likelihood ratios in the supervised approach. If there is not even a minimal evaluation set to begin with, w₁ can be adjusted incrementally from experience in the field.

6. Title Ranking as a Feature

Let {rk₁, rk₂} denote the ranks of the corporate titles of records r₁ and r₂. In one example, the set of ranks is {C-level, VP-level, Director-level, Manager-level, and Staff}. The title “Vice President of Sales” for example has the rank VP-level. When using title ranking as a feature, there is an extra complication, namely that of time elapsed. For example, suppose record r₁ is an earlier record compared to record r₂ of the same person. Further, suppose that the rank of the title in record r₁ is Manager-level and the rank of the title in record r₂ is VP-level. In the short term, this pair of ranks has a low probability of being for the same person, while the probability is a bit higher over a longer elapsed period of time.

However, the effect of time elapsed is likely to be significantly less than the effect of wide rank differences. For example, the probability of a person having the ranks Manager-level and C-level in different jobs is very low even allowing for a long elapsed time. By contrast, the probability of a person having the ranks Manager-level and Director-level in different jobs increases a lot, even if the elapsed time is great as well. In view of this, it is not unreasonable to make the simplifying assumption of ignoring the time dimension, i.e., averaging the estimates over different time durations. Thus, the training set only needs to be diverse enough to cover different elapsed times, and explicit information regarding elapsed time is not needed on individual pairs of records.

The probability P({rk₁, rk₂}|S, parameters) could be estimated from a large data set of work histories of people, if such a data set was available. Lacking such a data set, a set of reasonable, purely a priori belief-based estimates can be made. For example, one would expect P({C−level, staff}|S, assumptions) to be much much lower than P({Manager−level, staff}|S, parameters).

The probability P({rk₁, rk₂}|D, parameters) could be estimated similarly from a training set of D-labeled pairs of records {r₁, r₂}. This type of training set is even harder to come by. Moreover, there is a very simple and reasonable approximation to this estimate which can be achieved with a training set that is readily available, shown below:

P({rk₁,rk₂}|D,parameters}≈2*P(rk₁)*P(rk₂)

Here P(rk) is the probability of the title on a business card having a rank rk over the entire population of business cards. These probabilities are very easy to estimate from a large database of business cards.

7. Departments as a Feature

Let {d₁, d₂} denote the departments of the titles of records r₁ and r₂, according to a small fixed set of defined departments. For example, a typical set of departments might include “Sales”, “Marketing”, “Engineering”, “Human Resources”, etc.

The probability P({d₁, d₂}|S, parameters) could be estimated from a large data set of work histories of people, if such a data set was available. Lacking such a data set, we can still come up with reasonable, purely a priori belief-based estimates of the above quantity. For example, we would expect the probability P({Sales, Engineering}|S, parameters) to be much, much lower than the probability P({Sales, Marketing}|S, parameters).

The probability P({d₁, d₂}|D, parameters) could be estimated similarly from a training set of D-labeled pairs of records {r₁, r₂}, but this type of training set is even harder to come by. Moreover, there is a very simple and reasonable approximation for this estimate which can be achieved with a training set readily available.

P({d₁,d₂)|D,parameters}≈2*P(d₁)*P(d₂)

In this equation, P(d) is the probability of a title on the business card having department d over the entire population of business cards. These probabilities are very easy to estimate from a large database of business cards.

8. Addresses as a Feature

Let a=(str, c, sta, z, a) denote the street, city, state, zip, and country attributes of an address. Then let a₁=(str₁, c₁, sta₁, z₁, ct₁) and a₂=(str₂, c₂, sta₂, z₂, ct₂) denote the address attributes of records r₁ and r₂ respectively. The relevant probabilities are given by:

P({a₁a₂}|S,parameters) and P({a₁,a₂}|D,parameters).

Without any further parameters, the problem of effectively estimating these likelihoods is difficult. Specifically, huge training sets are needed to estimate them. However, rather than use the actual pairs of addresses, the distance between them may be used as a feature. Thus, in the two equations above, {a₁, a₂} is replaced by d(a₁, a₂), where d denotes the distance between the two addresses. Use of distance in this context makes intuitive sense. One would expect that people who change jobs tend to move nearby more often than not. On the other hand, different people with the same name in different companies will have a much wider, random distance distribution.

If geo-code information about the addresses is available, the Euclidean distance may be used as d. If not, a rough distance can be computed using the method described in U.S. Patent Pub. No. 2012/0023107, referenced above.

With these simplifications, reasonable size training sets will now suffice as a basis to estimate P(d(a₁, a₂)|S) and P(d(a₁, a₂)|D). Ideally, the training sets, even if they are not large, should be random samples from the populations of S and D. In practice, this just means that diverse data should be chosen for constructing the training sets. For example, for the S training set, the pairs of records chosen of the same person in different companies should cut across different geographic regions, different industries, different ranks, different departments, etc. In fact, if a training set for D is laborious to construct, one can get by without it. Using a flat likelihood P(d(a₁, a₂)|D), which treats all distances as equally likely, will provide adequate results.

9. Industries as a Feature

When people change companies, they tend to stay in the same industry more often than not. On the other hand, different people with the same name can of course be in arbitrary industries. In view of this, it makes sense to seek the probabilities:

P({i₁,i₂}|S,parameters) and P({i₁,i₂}|D,parameters)

where i₁ and i₂ are the industries of the two records.

The number of industries in practice tends to be no more than a few thousand (e.g. as in the SIC industry classification system), so these quantities can be estimated if large training sets are available. When this is not the case, simpler features may be used. Specifically, it is assumed that the industry system is an ordered system, as is the case for widely used systems such as SIC and NAICS. Let lca(i₁, i₂) denote the lowest common ancestor of two industries and i₂. Then the probabilities may be modeled as P(lca(i₁, i₂)|S) and P(lca(i₁, i₂)|D).

10. Computing Contact Clusters

Now that the score function of equation (1) has been developed in full detail (step 401), it is possible to start looking for clusters of contacts in different companies representing the same person. The database may have 30-50 million contacts, so an all-pairs comparison would be too slow. The process may be sped up by using a person name signature, such as the flast format, namely, the first letter of the first name, followed the last name, in lower case.

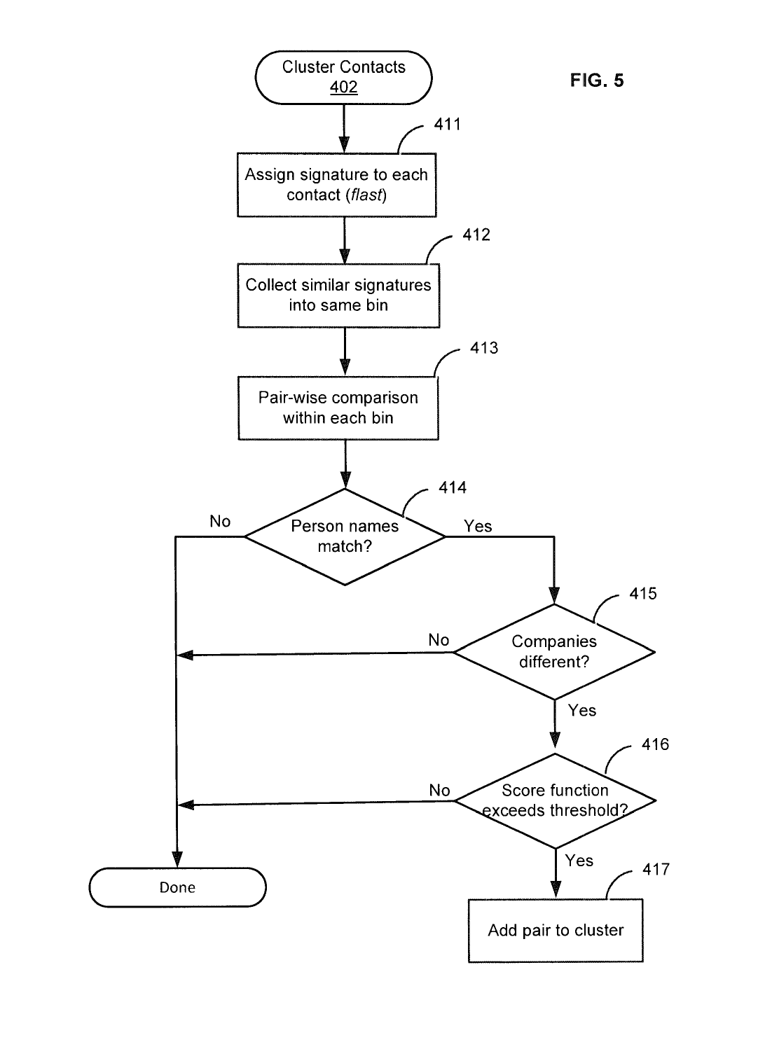

FIG. 5 illustrates one embodiment of a process 402 for clustering contacts of the same person. In step 411, all contacts assigned a person name signature, such as the flast signature. In step 412, all the contacts are placed into bins (dedicated buffers) according to theirflast signature, that is, similar names (according to the flast signature) are placed into the same bin. In step 413, a pair-wise comparison of all contacts in the same bin is performed across several features. If the pair-wise comparison reveals that the person names of the pair of records match in step 414, then proceed to step 415. If not, the process ends. In step 415, if the pair-wise comparison reveals that the companies of the pair of records are different, then proceed to step 416. If not, the process ends. In 416, if the score function for the pair-wise comparison reveals a high enough score, i.e., a score that exceeds some predefined threshold, then the pair of records are placed into the same cluster in step 417, indicating that the records belong to the same person. In a graphical structure, an edge is added between the record pair to connect them. Each set of connected components. i.e., connected by an edge, represents a cluster, namely, a group of business cards belonging to the same person.

11. Email Analysis

Next, methods are described for tying together business cards using personal email addresses. Personal email addresses can be a very reliable way of tying together different business cards of the same person.

As discussed above, each business card is a record or object stored in the database, and each record has a plurality of fields for storing attributes of the business card object, such as name, title, company, etc. Typically, each business card includes a business email address of the individual which uses a company-specific domain, such as <xyz@oracle.com>, which is the email address for an employee xyz of oracle.com. By contrast, personal email addresses are attributes of a person, and so belong to a person's profile, and not to their business card.

Advantageously for the methods described herein, a person's personal email address often remains unchanged when the person moves from one company to another. Further, the personal email address often appears in the same context as a business email address, for example, on the same business card, or in the text or header of the same email. This fact allows multiple business email addresses (and thus business cards) of the same individual, possibly across different companies, to get tied together.

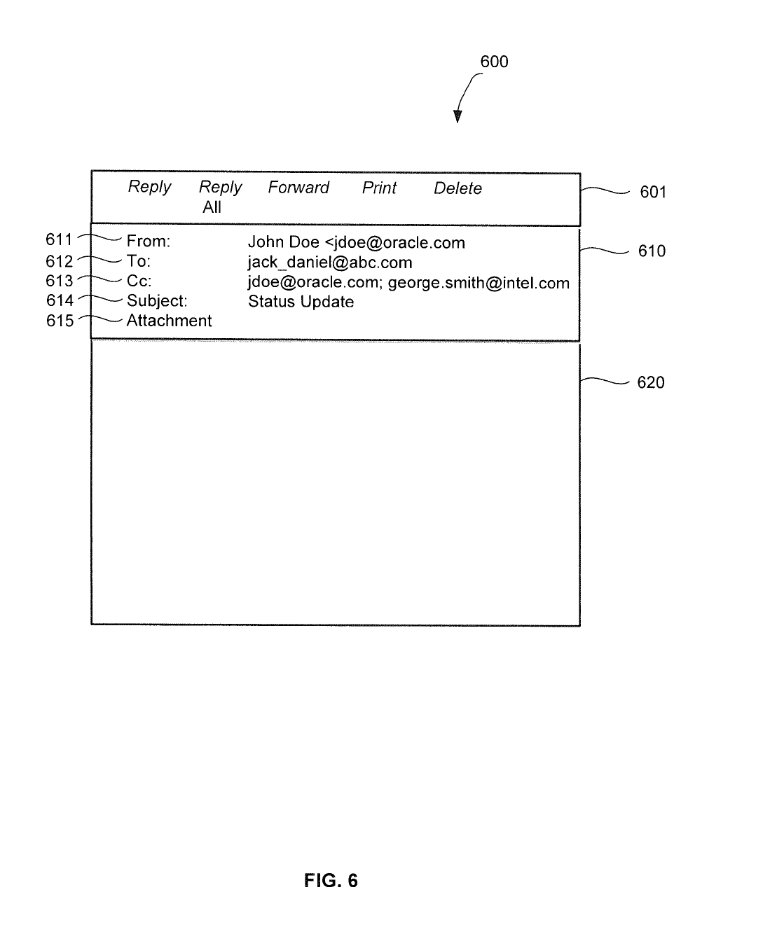

Consider the structure of a typical email message 600 as illustrated in FIG. 6. The message 600 includes two main parts: header fields 610, such as FROM 611, TO 612, CC 613, SUBJECT 614 and ATTACHMENT 615, and the body 620 containing the message. The message delivery system imposes a control header 601 onto message 600, which includes buttons or icons for functions such as REPLY, REPLY ALL, FORWARD, PRINT, DELETE, etc.

Email addresses, business and/or personal, are of course present in the various header fields 610 of message 600, but may also be found in one or more signature blocks in the body 620 of the message, and/or elsewhere in the body of the message. In many cases, person names may come ‘attached’ to these emails, or may be easy to infer. In an illustrative example, the email message 600 is sent by (John Doe <jdoe@oracle.com>), as indicated in the FROM field 611, to <jack_daniel@abc.com (whose person name is not known), as indicated in the TO field 612, and copied to <jdoe@oracle.com> and to <george.smith@intel.com>, as indicated in the CC field 613. In this example, the body 620 of message 600 contains a signature block from which the parser extracts the data (George Smith <george.smith@intel.com>). This could happen if George Smith sent an earlier email message which contained his signature block, and the present message 600 (sent by John Doe) includes the text of this previous message from George Smith, and so it also includes George Smith's signature block. This data pair, namely (<george.smith@intel.com>→George Smith), is added to a key/value map as described below. Finally, suppose that the message 600 also contains the email addresses <gsmith@gmail.com>, <jdoe@oracle.com>, and <johndoe@oracle.com> buried somewhere in its text. Although this example is contrived and perhaps unrealistic, it serves to illustrate the initial map construction and the map post-processing steps.

For example, the FROM field in many email delivery systems often indicates both the person name and the email address of the sender, as in field 611 in this example, namely (John Doe <jdoe@oracle.com>). The same may hold true for the TO field and the CC field, although sometimes the person name of the addressee is not known to the sender (or the email system), and therefore the email system obviously cannot add the name of the unknown person to the field. If an email address appears in a signature block, it can often be tied to a person name as well. If an email address appears elsewhere in the email body, we may or may not be able to tie it to a person name.

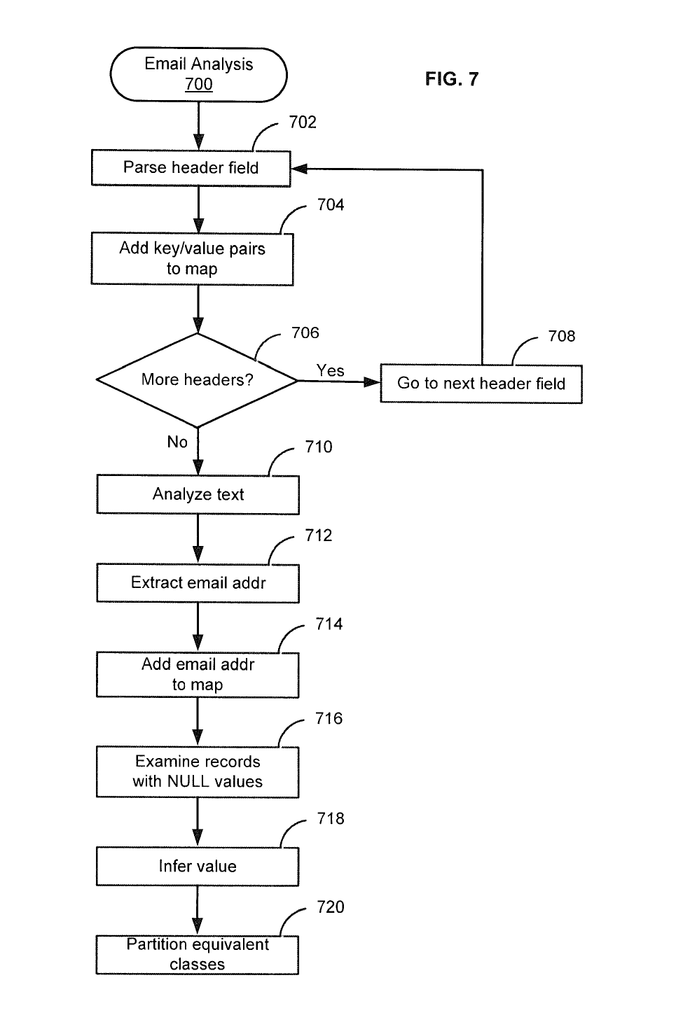

A method for analyzing the email message 600 is illustrated by process 700 in FIG. 7. In step 702, the header fields 610 of the message 600 are parsed to locate email addresses and, if available, corresponding person names associated with respective email addresses. Such parsing is well known and need not be described in detail herein. In step 704, a map of key/value pairs is built or updated using the information from the parsing step, as illustrated in Table I below, where the key is the email address and the value is the person name. If the person name is not known, it will be a null value.

For example, parsing the FROM header field 611 yields the pair (<jdoe@oracle.com>→John Doe), which is added to the map, e.g., Table I. Checking the TO field 612 results in the pair (<jack_daniel@abc.com>→null), which is also added to the map. Parsing the CC field 613 results in the pair (george.smith@intel.com→null), which may be ignored because <george.smith@intel.com> is already a key in the map.

Step 702 of process 700 starts with the FROM field 611, and in step 706, if there are more header fields to check, the next header field is selected in step 708 and parsed in step 702. If all the header fields have been parsed when checking in step 706, then the body of the email message 700 is parsed and analyzed in step 710, and any email addresses found therein are extracted in step 712 and added to the map in step 714.

In our example, checking the email message body 620 reveals the address <gsmith@gmail.com>, and thus the pair <gsmith@gmail.com>→null is added to the map. The email address <jdoe@oracle.com> is also found, but because it is already a key in the map it can be ignored. Address <johndoe@oracle.com> is also found, and therefore johndoe@oracle.com→null is also added to the map.

From the signature block, the pair <george.smith@intel.com>→George Smith may be inferred, but note that <george.smith@intel.com> was already a key in the map with a null value (person name), so this key has its value updated to George Smith.

TABLE I

| Email Address | | Person Name |
|---|---|---|
| jdoe@oracle.com | → | John Doe |
| george.smith@intel.com | → | George Smith |
| gsmith@gmail.com | → | null |
| jack_daniel@abc.com | → | null |
| jdoe@oracle.com | → | null |

It is easy to see from Table I that there are more dots to be connected. John Doe and George Smith each have two email addresses that need to be tied together. We can guess that the address <gsmith@gmail.com> is probably a personal email address since it is a gmail account, and not a company domain type account. Further, the format of the address <jack_daniel@abc.com> makes it easy to guess or infer the person name.

In step 716 of process 700, each record having null values is examined, and in step 718, the actual value is inferred from the key if possible. For example, such an inference can be drawn by splitting the email address head (in front of the @ character) on any occurrence of the a set of defined characters, such [-_\.]. If the split returns two parts both composed of alphabetic characters, then form the person name from these alphabetic characters. Thus, in our example, we would replace the null value corresponding to the key <jack_daniel@abc.com> in Table I with Jack Daniel.

In step 720, the key/value pairs are partitioned into equivalence classes, or clustered. Two key-value pairs are in the same equivalence class if and only if they represent the same person. Partitioning is achieved by using a function that scores any two key-value pairs in the map for how likely they are to represent the same person. For notational convenience, we refer to this score function as
score (email_address_1, person_name_1, email_address_2, person_name_2).

The scoring breaks down into three cases, discussed in more detail below:

Case 1—both person names are known: A matcher module called “person names matcher” is used to score the likelihood that the two names, while possibly having one or more superficial differences, are the same.

Case 2—one of the person names (e.g., person_name_1) is known: A matcher module called “person name to email prefix matcher” is used to score the consistency of the email prefix of email_address_2 to the person name person_name_1.

Case 3—neither person name is known: A matcher module called “email prefix to email prefix matcher” is used to score how likely it is that two different email prefixes are those of the same person.

It is important that these cases be examined in order. When both person names are known, matching the names is most accurate. When one person name is known, matching the person name to the other's email prefix is more accurate than matching two email prefixes.

Since the matching is being done in a very local context, i.e., the person names and email addresses are in a single email message—the probability of a false positive is very low. Consider a match of ‘John Smith’ to ‘John Smith.’ Even though ‘John Smith’ is a very common name, the probability that multiple occurrences of that name in a single email message represent different individuals is near-zero.

The “person names” matcher takes two person names, each name having a format of first_name and last_name, and returns a score indicating how likely they are to be the same person name. For example, (Bob Doe, Robert Doe), (Robert Doe, Robertt Doe), and (John Doe, Johnny Doe) should all return a relatively high score, whereas (John Williams, John Williamson) should return a somewhat low score. Thus, the matcher should accommodate first name aliases, some spelling errors, allow for a first name prefix match (e.g., John [symbol] Johnny, Ed [symbol] Eddy), but should be less tolerant of a last name prefix match in most cases (e.g., Williams and Williamson are different last names). Such a matcher is described in U.S. Patent Pub. No. 2012/0023107, referenced above.

The “person name to email prefix” matcher matches person names to email prefixes. Such a matcher would conclude, for example, that John Doe and <jdoe@xyz.com> match whereas John Doe and <tom.doley@xyz.com> do not match. This matcher can use a combination of pattern-based, prefix-based and string similarity-based approaches.

The pattern-based approach is motivated by the observation that email prefixes often tend to match a common pattern derived from the person's name. For example, jdoe would be the email prefix of John Doe based on the flast (first initial+full last name) pattern. Indeed, companies tend to assign email addresses to their employees in conformance with the company's email address pattern, which is typically a very common generic pattern such as flast.

The pattern-based component of the “person name to email prefix” matcher computes a set of plausible email prefixes from the person name, corresponding to a rich set of generic patterns. If the prefix of the email address is one of these candidate email prefixes, the email prefix is deemed to match the person name. Table II below is an incomplete list of patterns that are commonly used, illustrated for the person name John Doe.

TABLE II

| Pattern | Value |
|---|---|
| flast | jdoe |
| lastf | doej |
| firstlast | johndoe |
| lastfirst | doejohn |
| fl | jd |
| f[.-_]last | j[.-_]doe |
| first[.-_]last | john[.-_]doe |
| last[.-_]first | doe[.-_]john |

When the person name contains a middle name (or initial) as well, some additional patterns may be used, as illustrate for John Richards Doe in Table III below.

TABLE II

| Pattern | Value |
|---|---|
| fml | jrd |
| firstmlast | johnrdoe |
| fmlast | jrdoe |

Although one might think that the list of potential patterns is very large, the most common 20-30 patterns (which includes those listed in Tables II and III above) covers virtually all pattern-matching cases, and thus the matcher may implemented using look-ups such as the tables shown above.

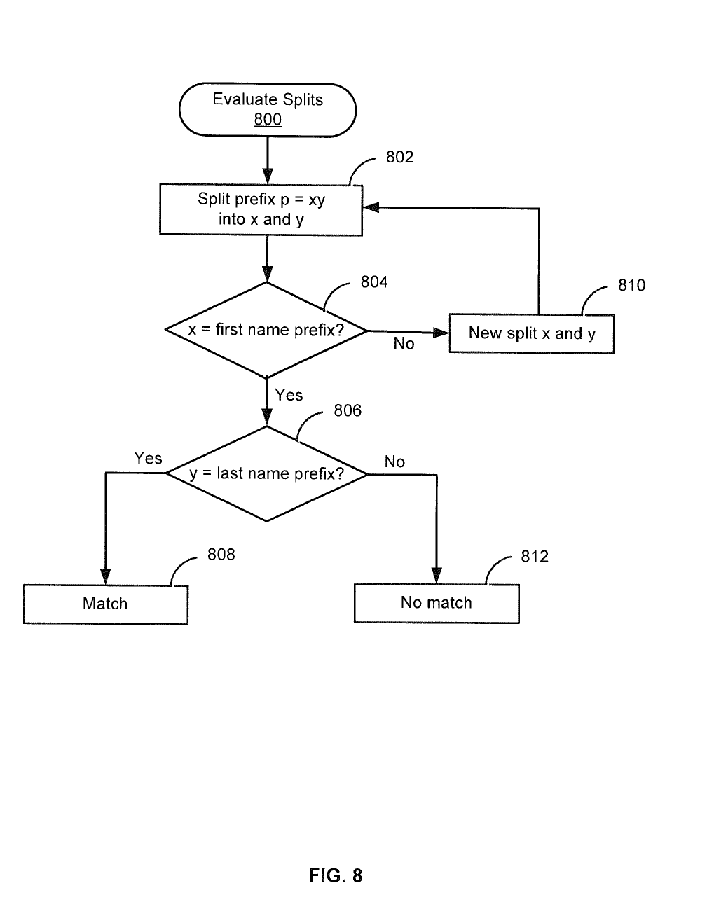

The prefixes-based approach is motivated by the following type of example: Adam Richards, <adrich@xyz.com>. This format is commonly used in very small companies (1-5 employees) and also in academia. In such cases, a match can be detected by process 800, as illustrated in FIG. 8. All variations of splits of the email prefix p of the form p=xy are evaluated in an iterative process, where the prefix p=the full term ‘adrich’. In step 802, the prefix p is split into portions x and y. In step 804, the x term is compared to the first name prefix. If x is a prefix of the first name, then in step 806, the y term is compared to the last name prefix. If y is a prefix of the last name, then the pattern is deemed to be matched in step 808.

If x is not a prefix of the first name in step 804, then a new split is made in step 810, and the process returns to step 804 to consider the new split. If y is not a prefix of the last name in step 806, then there is not match and the process ends in step 812.

The prefix may be split in any reasonable way. This technique also covers the extremes p=x and p=y, and, in one example, will correctly match Daniel Robinson and <dan@xyz.com>.

To generalize this approach a little more, consider the example pair (Rodney Weaver, <rod.w@xyz.com>). In one method, if the email prefix contains one of the following set of characters: ‘.’, ‘-’, or ‘_’, then split the prefix on that character, i.e., set p=x[.-_]y, and then do the usual tests, namely, is x a prefix of first_name, and is y a prefix of last_name? Further, since email prefixes tend to be short, even the exhaustive trying out of all possible splits (the number of which is the length of the prefix) does not take too long to calculate.

Another type of attribute that identifies a person (rather than merely a business card) is a social network handle. Some services will return a twitter handle when an email address is input. Such services can be used to map email addresses to twitter handles using methods similar to those described above, and thereby connect up multiple business cards, possibly across companies, to the same individual.

Note that an email address can ‘expire’ after a person moves to a new job, and thus, such a service may need to be used over different periods of time, with incremental recording of what is learned from it. For example, at one point in time, email address e maps to twitter handle t. At some later time, it is discovered that email address f maps to twitter handle t. Thus, using this information, the business card of e and the business card off may be tied together.

12. Partitioning

The actual partitioning is done via pair-wise comparisons of the email→person name entries using the matcher described previously. The method for doing the partitioning based on the results of the pair-wise matching is described in U.S. Patent Pub. No. 2012/0023107, which is referenced above and incorporated by reference. This method is familiar in the setting of graph clustering. Imagine a graph whose nodes are the email addr→person name entries, and whose edges are matching pairs of nodes. Since matches are expected to be transitive (if a matches b and b matches c then a matches c), this graph partitions into cliques (i.e., fully-connected subgraphs). A data structure called disjoint-set collection may be used in conjunction with a simple method to recover these cliques from the edges in the graph. The cliques represent clusters of matches.

A method to recover cliques from the edges in the graph can be implemented in a few lines of Ruby programming, thus leveraging the power of sets in Ruby, for example:

email_clusters=emails_map.keys.to_set.divide{|email1,email2|

score(email1,emails_map[email1],email2,emails_map[email2])>=THRESH}

In this example, the parameter ‘emails_map[email]’ returns the person name that ‘email’ is mapped to.

From the data structure ‘email_clusters,’ which is a collection of sets, and ‘emails_map,’ three new data structures are constructed as follows:

(1) A map P={person name→email address}. The keys of this map are person names, and each key is mapped to the set of zero or more email addresses of that person.

(2) A (possibly empty) set E of sets of ‘orphan’ email addresses, i.e., ones whose person names are not known. The reason that this is a partition (set of sets) is because it may be possible to tell that some of the email addresses correspond to the same person even though that person name remains unknown.

(3) Three sets personal, business, unknown that put every email address in exactly one of these bins. unknown is used to cover the case when a method is unable to guess with high confidence that the email is either personal or business.

Initially, these three data structures are empty. Each of the clusters C in the parameter ‘email_clusters’ is examined one by one and processed as follows: Using the parameter ‘emails_map,’ the set P(C) of non-empty person names in cluster C is constructed. If P(C) is empty, then cluster C is added as a new set to set E. If P(C) is not empty, an arbitrary member p from P(C) is chosen and the entry e→C is added to P. During this process, when each distinct email address e is first encountered, the method guess_type(e) described below is invoked and e is put into either personal, business or unknown.
PERSONAL_DOMAINS=[‘yahoo.com’,‘gmail.com’].to_set
def guess_type(email)
   return :personal if PERSONAL_DOMAINS.include?(email.domain)
   return :business
end

Another example illustrates this partitioning process on a slightly enhanced version of the prior example. The starting point is shown in Table IV below:

TABLE IV

| Email Address | | Person Name |
|---|---|---|
| jdoe@oracle.com | → | John Doe |
| george.smith@intel.com | → | George Smith |
| gsmith@gmail.com | → | null |
| jack_daniel@abc.com | → | Jack Daniel |
| jdoe@oracle.com | → | null |
| ron@zlist.com | → | null |

The partitioning process produces four email clusters: {jdoe@oracle.com, johndoe@oracle.com}; {george.smith@intel.com, gsmith@gmail.com}; {jack_daniel@abc.com}; and {ron@zlist.com}. The first three clusters have person names associated with them in Table IV, while the last one does not. This leads to the final data structures, namely the set P of person names, as shown in Table V:

TABLE V

| Person Name | | Email Address |
|---|---|---|
| John Doe | → | jdoe@oracle.com, |
| | | johndoe@oracle.com |
| George Smith | → | george.smith@intel.com, |
| | | gsmith@gmail.com |
| Jack Daniel | → | jack_daniel@abc.com |

and the set E without person names, as shown in Table VI:

TABLE V

| Person Name | | Email Address |
|---|---|---|
| null | → | ron@zlist.com |

Consider another example. Suppose the business card database includes a contact record for John Doe, <jdoe@intel.com>, VP Engineering, Intel Corporation. Now suppose another contact record is obtained for the database, e.g., via JFS or bulk load, namely the record for John Doe, <jdoe@gmail.com>, VP Engineering, Intel Corporation. The contact matcher described in U.S. Patent Pub. No. 2012/0023107, referenced above, will match these two records without using their emails, for example, based on the match in name, title and company fields. From this match, it is learned that <jdoe@gmail.com> is another email address of the John Doe contact originally stored in the database. Furthermore, since this is a personal email address, it can be made an attribute of the person.

Now suppose at some later time the following record comes from an outside source to the database: John Doe, doe@gmail.com, XYZ Inc. Using the email address <jdoe@gmail.com>, the methods described herein are able to match it up to the correct person, and thus the two versions of John Doe, at different companies, have been tied together.

The methods for email analysis and social media handle analysis are complementary to cross-company business card matching, and thus, these methods should increase the yield (i.e., the number of distinct person profiles that get produced) significantly relative to using just cross-company business card matching.

13. More Detailed Description of Hardware/Software Environment

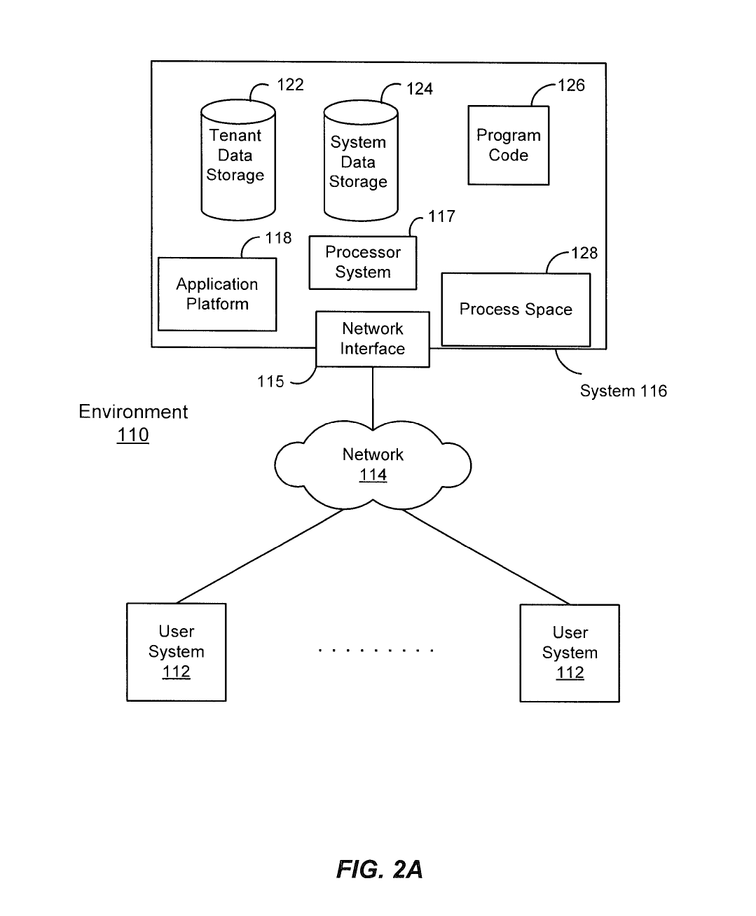

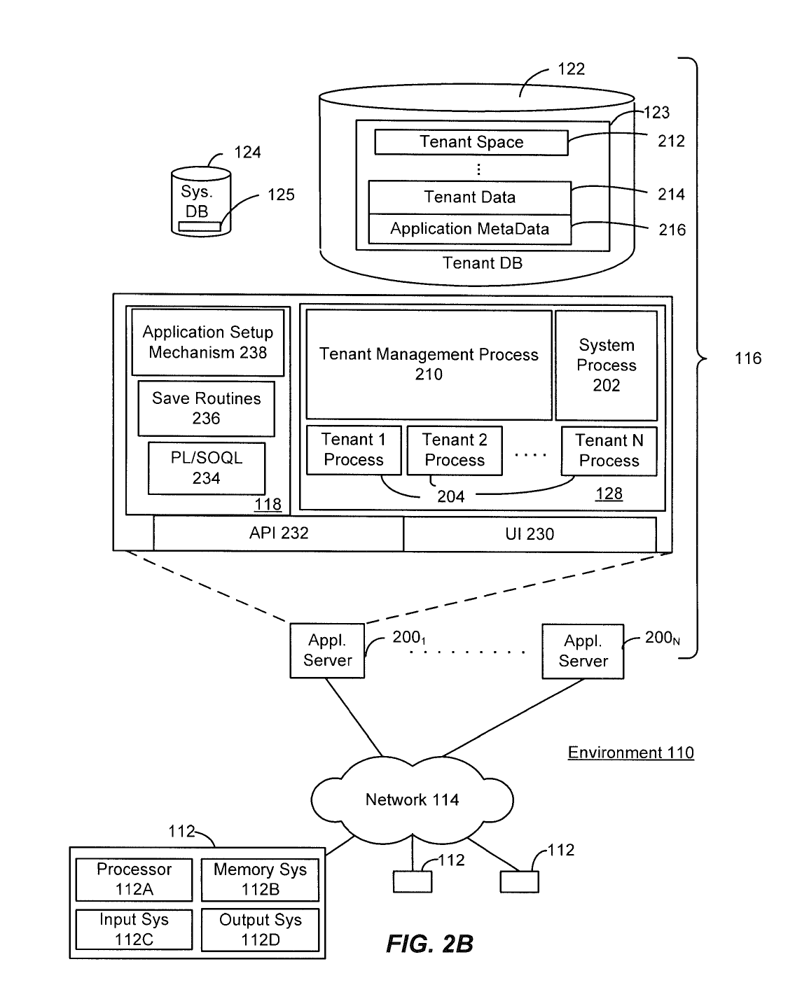

FIG. 2A is a more detailed block diagram of an exemplary environment 110 for use of an on-demand database service. Environment 110 may include user systems 112, network 114 and system 116. Further, the system 116 can include processor system 117, application platform 118, network interface 120, tenant data storage 122, system data storage 124, program code 126 and process space 128. In other embodiments, environment 110 may not have all of the components listed and/or may have other elements instead of, or in addition to, those listed above.

User system 112 may be any machine or system used to access a database user system. For example, any of the user systems 112 could be a handheld computing device, a mobile phone, a laptop computer, a work station, and/or a network of computing devices. As illustrated in FIG. 2A (and in more detail in FIG. 2B), user systems 112 might interact via a network 114 with an on-demand database service, which in this embodiment is system 116.

An on-demand database service, such as system 116, is a database system that is made available to outside users that are not necessarily concerned with building and/or maintaining the database system, but instead, only that the database system be available for their use when needed (e.g., on the demand of the users). Some on-demand database services may store information from one or more tenants into tables of a common database image to form a multi-tenant database system (MTS). Accordingly, the terms “on-demand database service 116” and “system 116” will be used interchangeably in this disclosure. A database image may include one or more database objects or entities. A database management system (DBMS) or the equivalent may execute storage and retrieval of information against the database objects or entities, whether the database is relational or graph-oriented. Application platform 118 may be a framework that allows the applications of system 116 to run, such as the hardware and/or software, e.g., the operating system. In an embodiment, on-demand database service 116 may include an application platform 118 that enables creation, managing and executing one or more applications developed by the provider of the on-demand database service, users accessing the on-demand database service via user systems 112, or third party application developers accessing the on-demand database service via user systems 112.

The users of user systems 112 may differ in their respective capacities, and the capacity of a particular user system 112 might be entirely determined by permission levels for the current user. For example, where a salesperson is using a particular user system 112 to interact with system 116, that user system has the capacities allotted to that salesperson. However, while an administrator is using that user system to interact with system 116, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 114 is any network or combination of networks of devices that communicate with one another. For example, network 114 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global network of networks often referred to as the Internet, that network will be used in many of the examples herein. However, it should be understood that the networks that the one or more implementations might use are not so limited, although TCP/IP is a frequently implemented protocol.

User systems 112 might communicate with system 116 using TCP/IP and, at a higher network level, use other common Internet protocols to communicate, such as HTTP, FTP, AFS, WAP, etc. In an example where HTTP is used, user system 112 might include an HTTP client commonly referred to as a browser for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least as for the users that are accessing that server, each of the plurality of servers has access to the data stored in the MTS; however, other alternative configurations may be used instead.

In one embodiment, system 116 implements a web-based customer relationship management (CRM) system. For example, in one embodiment, system 116 includes application servers configured to implement and execute CRM software applications as well as provide related data, code, forms, web pages and other information to and from user systems 112 and to store to, and retrieve from, a database system related data, objects, and Web page content. With a multi-tenant system, data for multiple tenants may be stored in the same physical database object; however, tenant data typically is arranged so that data of one tenant is kept logically separate from that of other tenants so that one tenant does not have access to another tenant's data, unless such data is expressly shared. In certain embodiments, system 116 implements applications other than, or in addition to, a CRM application. For example, system 116 may provide tenant access to multiple hosted (standard and custom) applications, including a CRM application. User (or third party developer) applications, which may or may not include CRM, may be supported by the application platform 118, which manages creation, storage of the applications into one or more database objects and executing of the applications in a virtual machine in the process space of the system 116.

One arrangement for elements of system 116 is shown in FIG. 2B, including a network interface 120, application platform 118, tenant data storage 122 for tenant data 123, system data storage 124 for system data 125 accessible to system 116 and possibly multiple tenants, program code 126 for implementing various functions of system 116, and a process space 128 for executing MTS system processes and tenant-specific processes, such as running applications as part of an application hosting service. Additional processes that may execute on system 116 include database indexing processes.

Several elements in the system shown in FIG. 2A include conventional, well-known elements that are explained only briefly here. For example, each user system 112 could include a desktop personal computer, workstation, laptop, PDA, cell phone, or any wireless access protocol (WAP) enabled device or any other computing device capable of interfacing directly or indirectly to the Internet or other network connection. User system 112 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 112 to access, process and view information, pages and applications available to it from system 116 over network 114. Each user system 112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a central processing unit such as processor system 117, which may include an Intel Pentium® processor or the like, and/or multiple processor units. A computer program product embodiment includes a machine-readable storage medium (media) having stored instructions which can be used to program a computer to perform any of the processes of the embodiments described herein. Computer code for operating and configuring system 116 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 116 is configured to provide web pages, forms, applications, data and media content to user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2B also illustrates environment 110. However, in FIG. 2B elements of system 116 and various interconnections in an embodiment are further illustrated. FIG. 2B shows that a typical user system 112 may include processor system 112A, memory system 112B, input system 112C, and output system 112D. FIG. 3 shows network 114 and system 116. FIG. 2B also shows that system 116 may include tenant data storage 122, tenant data 123, system data storage 124, system data 125, User Interface (UI) 230, Application Program Interface (API) 232, PL/SOQL 234, save routines 236, application setup mechanism 238, applications servers 200₁-200_{N}, system process space 202, tenant process spaces 204, tenant management process space 210, tenant storage area 212, user storage 214, and application metadata 216. In other embodiments, environment 110 may not have the same elements as those listed above and/or may have other elements instead of, or in addition to, those listed above.

User system 112, network 114, system 116, tenant data storage 122, and system data storage 124 were discussed above in FIG. 2A. Regarding user system 112, processor system 112A may be any combination of one or more processors. Memory system 112B may be any combination of one or more memory devices, short term, and/or long term memory. Input system 112C may be any combination of input devices, such as one or more keyboards, mice, trackballs, scanners, cameras, and/or interfaces to networks. Output system 112D may be any combination of output devices, such as one or more monitors, printers, and/or interfaces to networks.

As shown by FIG. 2B, system 116 may include a network interface 115 (of FIG. 2) implemented as a set of HTTP application servers 200, an application platform 118, tenant data storage 122, and system data storage 124. Also shown is system process space 202, including individual tenant process spaces 204 and a tenant management process space 210. Each application server 200 may be configured to tenant data storage 122 and the tenant data 123 therein, and system data storage 124 and the system data 125 therein to serve requests of user systems 112. The tenant data 123 might be divided into individual tenant storage areas 212, which can be either a physical arrangement and/or a logical arrangement of data. Within each tenant storage area 212, user storage 214 and application metadata 216 might be similarly allocated for each user. For example, a copy of a user's most recently used (MRU) items might be stored to user storage 214. Similarly, a copy of MRU items for an entire organization that is a tenant might be stored to tenant storage area 212. A UI 230 provides a user interface and an API 232 provides an application programmer interface to system 116 resident processes to users and/or developers at user systems 112. The tenant data and the system data may be stored in various databases, such as one or more Oracle™ databases, or in distributed memory.

Application platform 118 includes an application setup mechanism 238 that supports application developers' creation and management of applications, which may be saved as metadata into tenant data storage 122 by save routines 236 for execution by subscribers as one or more tenant process spaces 204 managed by tenant management process 210 for example. Invocations to such applications may be coded using PL/SOQL 234 that provides a programming language style interface extension to API 232. A detailed description of some PL/SOQL language embodiments is discussed in commonly owned, co-pending U.S. Provisional Patent App. No. 60/828,192, entitled Programming Language Method And System For Extending APIs To Execute In Conjunction With Database APIs, filed Oct. 4, 2006, which is incorporated in its entirety herein for all purposes. Invocations to applications may be detected by one or more system processes, which manages retrieving application metadata 216 for the subscriber making the invocation and executing the metadata as an application in a virtual machine.

Each application server 200 may be coupled for communications with database systems, e.g., having access to system data 125 and tenant data 123, via a different network connection. For example, one application server 200₁ might be coupled via the network 114 (e.g., the Internet), another application server 200_{N-1} might be coupled via a direct network link, and another application server 200_{N} might be coupled by yet a different network connection. Transfer Control Protocol and Internet Protocol (TCP/IP) are typical protocols for communicating between application servers 200 and the database system. However, it will be apparent to one skilled in the art that other transport protocols may be used to optimize the system depending on the network interconnect used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, an interface system implementing a load balancing function (e.g., an F5 Big-IP load balancer) is coupled for communication between the application servers 200 and the user systems 112 to distribute requests to the application servers 200. In one embodiment, the load balancer uses a “least connections” algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, system 116 is multi-tenant and handles storage of and access to, different objects, data and applications across disparate users and organizations.

As an example of storage, one tenant might be a company that employs a sales force where each salesperson uses system 116 to manage their sales process. Thus, a user might maintain contact data, leads data, customer follow-up data, performance data, goals and progress data, etc., all applicable to that user's personal sales process (e.g., in tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be shared organization-wide or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 116 might also maintain system level data usable by multiple tenants or other data. Such system level data might include industry reports, news, postings, and the like that are sharable among tenants.

In certain embodiments, user systems 112 (which may be client systems) communicate with application servers 200 to request and update system-level and tenant-level data from system 116 that may require sending one or more queries to tenant data storage 122 and/or system data storage 124. System 116 (e.g., an application server 200 in system 116) automatically generates one or more SQL statements (e.g., one or more SQL queries) that are designed to access the desired information. System data storage 124 may generate query plans to access the requested data from the database.

14. Conclusion

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for building a profile record for a person, comprising:
extracting from an email message an email address and, if present in the email message, a person name corresponding to the email address;
storing a first record in a database having a first key/value pair, wherein the extracted email address is stored as the first key and the corresponding person name is stored as the first value, and if there is no corresponding person name then storing null as the first value;
determining an actual value from the email message if the first value is null, and storing the actual value as the first value;
retrieving a second record from the database having a second key/value pair;
scoring the likelihood that the first record and the second record represent the same person;
grouping the first and second records together if the scoring step exceeds a threshold; and
building a profile record for the person from the grouped records.

2. The method of claim 1, wherein the extracting step comprises:
parsing the header fields of the email message to look for email addresses and corresponding person names; and
parsing the body of the email message to look for email addresses and corresponding person names.

3. The method of claim 2, further comprising parsing the header fields before parsing the body.

4. The method of claim 1, the determining step comprising inferring a person name by splitting a prefix of the email address.

5. The method of claim 4, further comprising splitting the prefix on a defined character, wherein if the split results in two parts each having a plurality of alphabetic characters, then the person name if formed from the two parts.

6. The method of claim 1, wherein the first and second records have known person names stored as values, the scoring step further comprising:
evaluating a match between the known person names.

7. The method of claim 1, wherein first record has a null value for the person name and the second record has a known person name stored as the value, the scoring step further comprising:
evaluating a match between the known person name and an email prefix for the email address stored in the first record.

8. The method of claim 1, wherein first and second records have null values for the person names, the scoring step further comprising:
evaluating a match between an email prefix for the email address stored in the first record and an email prefix for the email address stored in the second record.

9. The method of claim 4, the inferring step further comprising:
splitting the prefix into a first part and a second part;
wherein if the first part is equal to a first name prefix and the second part is equal to a last name prefix, then the first part is set equal to the first name of the person name and the second part is equal to the last name of the person name.

10. A non-transitory machine-readable medium having stored thereon one or more sequences of instructions for building a profile record for a person, the instructions comprising:
extracting from an email message an email address and, if present in the email message, a person name corresponding to the email address;
storing a first record in a database having a first key/value pair, wherein the extracted email address is stored as the first key and the corresponding person name is stored as the first value, and if there is no corresponding person name then storing null as the first value;
determining an actual value from the email message if the first value is null, and storing the actual value as the first value;
retrieving a second record from the database having a second key/value pair;
scoring the likelihood that the first record and the second record represent the same person;
grouping the first and second records together if the scoring step exceeds a threshold; and
building a profile record for the person from the grouped records.

11. The machine-readable medium of claim 10, wherein the extracting step comprises:
parsing the header fields of the email message to look for email addresses and corresponding person names; and
parsing the body of the email message to look for email addresses and corresponding person names.

12. The machine-readable medium of claim 10, the determining step comprising inferring a person name by splitting a prefix of the email address on a defined character, wherein if the split results in two parts each having a plurality of alphabetic characters, then the person name if formed from the two parts.

13. The machine-readable medium of claim 10, wherein the first and second records have known person names stored as values, the scoring step further comprising:
evaluating a match between the known person names.

14. The machine-readable medium of claim 10, wherein first record has a null value for the person name and the second record has a known person name stored as the value, the scoring step further comprising:
evaluating a match between the known person name and an email prefix for the email address stored in the first record.

15. The machine-readable medium of claim 10, wherein first and second records have null values for the person names, the scoring step further comprising:
evaluating a match between an email prefix for the email address stored in the first record and an email prefix for the email address stored in the second record.

16. The machine-readable medium of claim 12, the inferring step further comprising:
splitting the prefix into a first part and a second part;
wherein if the first part is equal to a first name prefix and the second part is equal to a last name prefix, then the first part is set equal to the first name of the person name and the second part is equal to the last name of the person name.

17. An apparatus for building a profile record for a person, the apparatus comprising:
a processor coupled to the database; and
one or more stored sequences of instructions which, when executed by the processor, cause the processor to carry out the steps of:
extracting from an email message an email address and, if present in the email message, a person name corresponding to the email address;
storing a first record in a database having a first key/value pair, wherein the extracted email address is stored as the first key and the corresponding person name is stored as the first value, and if there is no corresponding person name then storing null as the first value;
determining an actual value from the email message if the first value is null, and storing the actual value as the first value;
retrieving a second record from the database having a second key/value pair;
scoring the likelihood that the first record and the second record represent the same person;
grouping the first and second records together if the scoring step exceeds a threshold; and
building a profile record for the person from the grouped records.

18. The apparatus of claim 17, wherein the first and second records have known person names stored as values, the scoring instruction further comprising:
evaluating a match between the known person names.

19. The apparatus of claim 17, wherein first record has a null value for the person name and the second record has a known person name stored as the value, the scoring instruction further comprising:
evaluating a match between the known person name and an email prefix for the email address stored in the first record.

20. The apparatus of claim 17, wherein first and second records have null values for the person names, the scoring instruction further comprising:
evaluating a match between an email prefix for the email address stored in the first record and an email prefix for the email address stored in the second record.
